(19) United States
(12) Patent Application Publication
(10) Pub. No.: US 2002/0049875 A1
(43) Pub. Date: Apr. 25, 2002

(54) Data communications interfaces

(76) Inventors: Biran Giora, Zichran Ya'akov, IL (US); Tal Sostheim, Kiryak Tivon (IL)

Correspondence Address: Ronald L. Drumheller, Esq., 94 Teakettle Spout Road, Mahopac, NY, 10541, US

(21) Appl. No.: 09/773,227

(22) Filed: Jan. 31, 2001

(30) Foreign Application Priority Data
Oct. 23, 2000 (EP) EP00122992.1

(51) Int. Cl. G06F 13/00

(52) U.S. Cl. 710/301

(57) ABSTRACT

A data communications interface for a node of data processing network comprises a data transmission path, a transmission control path, a data reception path, and a reception control path. Transmission segmentation logic receives a data frame, comprising a transmission header and a transmission payload, from the node. The transmission segmentation logic supplies the transmission payload to the data transmission path and the transmission header to the transmission control path. A transmission processor in the transmission control path controls communication of data from the transmission payload to the network via the data transmission path in dependence on the transmission header. Reception segmentation logic receives a data packet, comprising a reception header and a reception payload, from the network. The reception segmentation logic supplies the reception payload to the data reception path and the reception header to the reception control path. A reception processor in the reception control path controls communication of data from the reception payload to the node via the data reception path in dependence on the reception header.

The present invention relates to data communications interfaces for nodes of a data processing network.

A conventional data processing network comprises a plurality of host computer systems and a plurality of attached devices all interconnected by an intervening network architecture such as an Ethernet architecture. The network architecture typically comprises one or more data communications switches. The host computer systems and the attached devices each form a node in the data processing network. Each host computer system typically comprises a plurality of central processing units and data storage memory device interconnected by a bus architecture such as a PCI bus architecture. A network adapter is also connected to the bus architecture for communicating data between the host computer system and other nodes in the data processing network via the network architecture. It would be desirable for the network adapter to facilitate transfer of data between the bus architecture of the computer system and the network architecture as efficiently as possible.

In accordance with the present invention, there is now provided a data communications interface for a node of data processing network, the interface comprising: a data transmission path; a transmission control path; transmission segmentation logic for receiving a data frame, comprising a transmission header and a transmission payload, from the node and supplying the transmission payload to the data transmission path and the transmission header to the transmission control path; a transmission processor in the transmission control path for controlling communication of data from the transmission payload to the network via the data transmission path in dependence on the transmission header; a data reception path; a reception control path; reception segmentation logic for receiving a data packet, comprising a reception header and a reception payload, from the network and supplying the reception payload to the data reception path and the reception header to the reception control path; and, a reception processor in the reception control path for controlling communication of data from the reception payload to the node via the data reception path in dependence on the reception header.

By arranging for the transmission and reception processors to process only header information, data can be efficiently transferred through the interface from source to destination with minimum delay.

Preferred embodiments of the present invention comprise: a shared memory and a local bus providing access to the shared memory by the transmission and reception processors. The shared memory preferably comprises a store for control information to be used by the transmission and reception processors in controlling said flows of data. Particularly preferred embodiments of the present invention comprises a communication path for communicating information between the transmission and reception processors via the shared memory.

Especially preferred embodiments of the present invention comprise bus interface logic for connecting the local bus, the transmission data channel, and the reception data channel to the bus architecture of the node.

The present invention extends to a network interface card for insertion into a computer system, the network interface card comprising a printed circuit board and a data communications interface as hereinbefore described mounted on the printed circuit board. The present invention also extends to an application specific integrated circuit comprising an application specific integrated circuit comprising a data communications interface as hereinbefore described. The present invention further extends to a computer system comprising: a cental processing unit; a memory; a data communications interface as hereinbefore described; and, a bus architecture interconnecting the central processing unit, the memory, and the data communications interface. The present invention furthermore extends to a data processing network comprising a plurality of such computer systems and a network architecture interconnected the computer systems.

Viewing the present invention from another aspect, there is now provided a method of communicating data to and from a node in a data processing network, the method comprising: receiving, via transmission segmentation logic, a data frame, comprising a transmission header and a transmission payload, from the node; supplying, via the transmission segmentation logic, the transmission payload to a data transmission path and the transmission header to a transmission control path; controlling, via a transmission processor in the transmission control path, communication of data from the transmission payload to the network via the data transmission path in dependence on the transmission header; receiving, via reception segmentation logic, a data packet, comprising a reception header and a reception payload, from the network; supplying, via the reception segmentation logic, the reception payload to a data reception path and the reception header to a reception control path; and, controlling, via a reception processor in the reception control path, communication of data from the reception payload to the node via the data reception path in dependence on the reception header.

Preferred embodiments of the present invention will now be described, by way if example only, with reference to the accompanying drawings, in which:

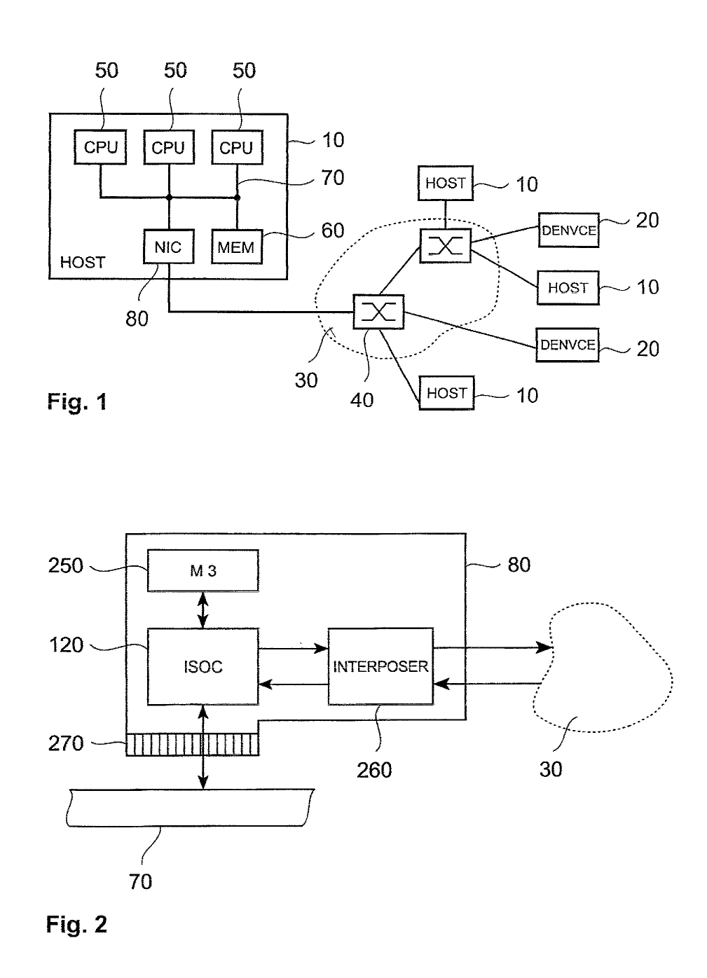

FIG. 1 is a block diagram of an example of a data processing network;

FIG. 2 is a block diagram of a network interface adapter card for the data processing network;

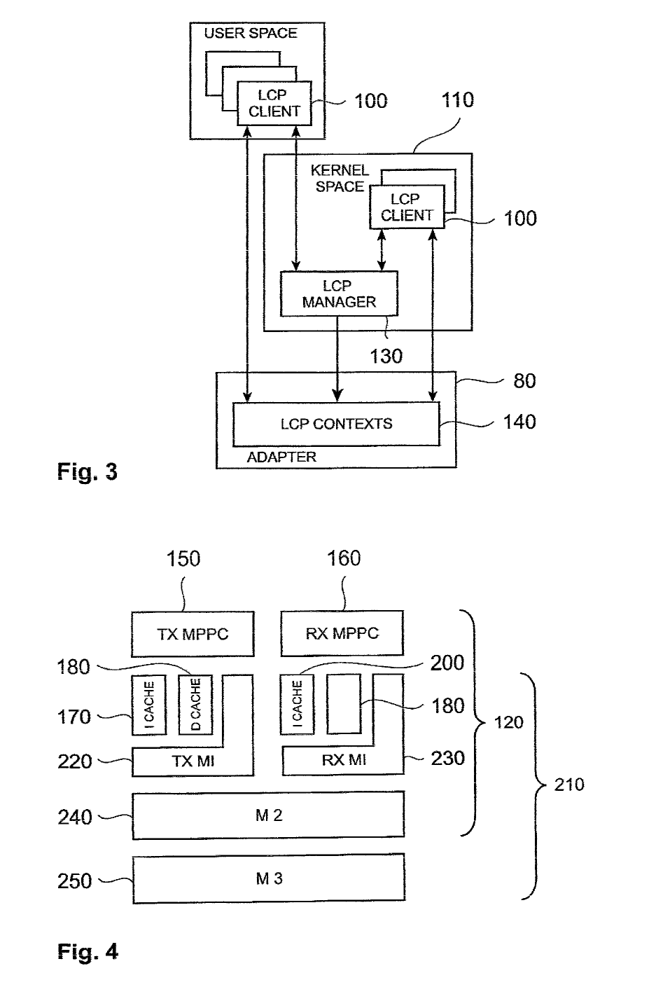

FIG. 3 is a block diagram of an example of a host computer system for the data network;

FIG. 4 is a block diagram of an example of an Integrated System on a Chip (ISOC) for the network adapter card;

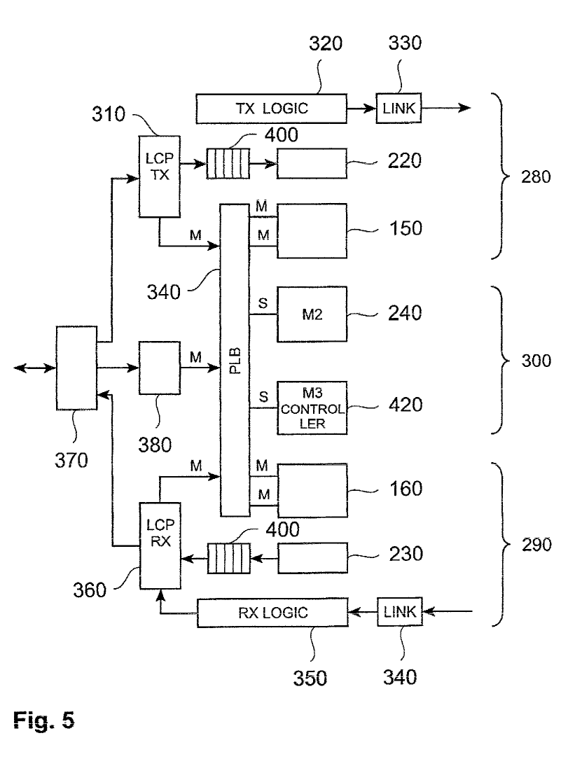

FIG. 5 is another block diagram of the ISOC;

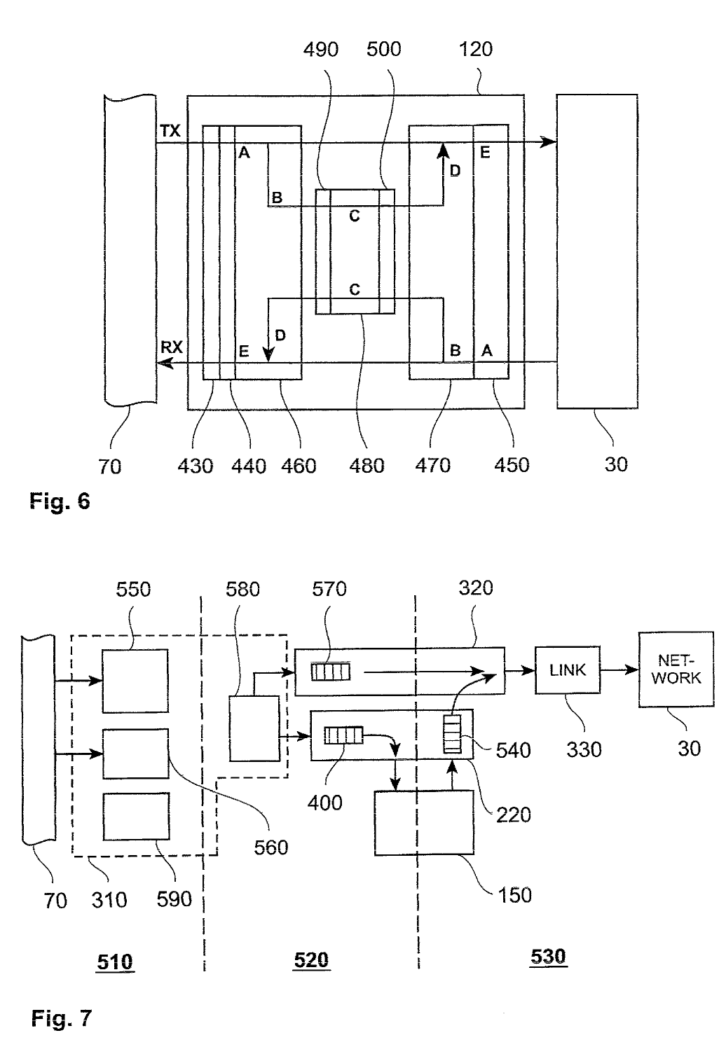

FIG. 6 is a block diagram of the ISOC demonstrating information flow through the ISOC;

FIG. 7 is a block diagram of a logical transmit path through the ISOC; and,

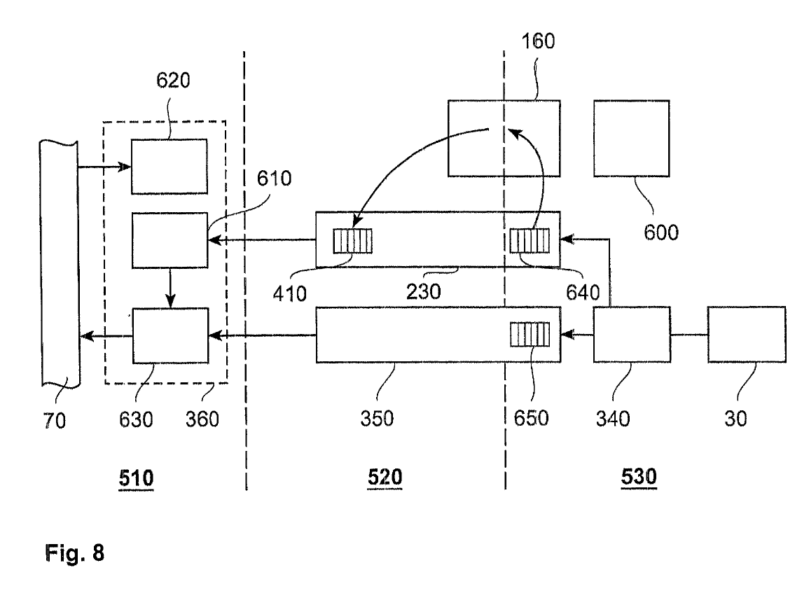

FIG. 8 is a block diagram of a logical receive path through the ISOC.

Referring first to FIG. 1, an example of a data processing network embodying the present invention comprises a plurality of host computer systems 10 and a plurality of attached devices 20 interconnected by an intervening network architecture 30 such as an Ethernet or an

InfiniBand network architecture (InfiniBand is a trade mark of the InfiniBand Trade Association). The network architecture 30 typically comprises a plurality of data communications switches 40. The host computer systems 10 and the attached devices 20 each form a node in the data processing network. Each host computer system 10 comprises a plurality of central processing units (CPUs) 50, and a memory 60 interconnected by a bus architecture 70 such as a PCI bus architecture. A network adapter 80 is also connected to the bus architecture for communicating data between the host computer system 10 and other nodes in the data processing network via the network architecture 30.

Referring now to FIG. 2, in particularly preferred embodiments of the present invention, the network adapter 80 comprises a pluggable option card having a connector such as an edge connector for removable insertion into the bus architecture 70 of the host computer system 10. The option card carries an Application Specific Integrated Circuit (ASIC) or Integrated System on a Chip (ISOC) 120 connectable to the bus architecture 70 via the connector 170, one or more third level memory modules 250 connected to the ISOC 120, and an interposeer 260 connected to the ISOC 120 for communicating data between the media of the network architecture 30 and the ISOC 120. The interposer 260 provides a physical connection to the network 30. In some embodiments of the present invention, the interposer 260 may be implemented in a single ASIC. However, in other embodiments of the present invention, the interposer 260 may be implemented by multiple components. For example, if the network 30 comprises an optical network, the interposer 260 may comprise a retimer driving a separate optical transceiver. The memory 250 may be implemented by SRAM, SDRAM, or a combination thereof. Other forms of memory may also be employed in the implementation of memory 250. The ISOC includes first and second memory. The memory subsystem of the adapter 80 will be described shortly. As will become apparent from the following description, this arrangement provides: improved performance of distributed applications operating on the data processing network; improved system scaleability; compatibility with a range of communication protocols; and reduced processing requirements in the host computer system. More specifically, this arrangement permits coexistence of heterogeneous communication protocols between the adapters 80 and the host systems 10. Such protocols can serve various applications, use the same adapter 80, and use a predefined set of data structures thereby enhancing data transfers between the host and the adapter 80. The number of application channels that can be opened in parallel is determined by the amount of memory resources allocated to the adapter 80 and is independent of processing power embedded in the adapter. It will be appreciated from the following that the ISOC 120 concept of integrating multiple components into a single integrated circuit chip component advantageously minimizes manufacturing costs and in provides reusable system building blocks. However, it will also be appreciated that in other embodiments of the present invention, the elements of the ISOC 120 may be implemented by discrete components.

In the following description, the term Frame refers to data units or messages transferred between software running on the host computer system 10 and the adapter 80. Each Frame comprises a Frame Header and a data payload. The data payload may contain user data, high level protocol header data, acknowledgments, flow control or any combination thereof. The contents of the Frame Header will be described in detail shortly. The adapter 80 processes only the Frame Header. The adapter 80 may fragment Frames into smaller packets which are more efficiently transported on the network architecture 30. However, such fragmentation generally does not transform the data payload.

In particularly preferred embodiment of the present invention, data is transported on the network architecture 30 in atomic units hereinafter referred to as Packets. Each Packet comprises route information followed by hardware header data and payload data. In a typical example of the present invention, a packet size of up to 1024 bytes is employed. Frames of larger size are fragmented into 1024 byte packets. It will be appreciated that in other embodiments of the present invention, different packet sizes may be employed.

In a preferred embodiment of the present invention, communications between the adapter 80 and multiple applications running on the host computer system 10 are effected via a Logical Communication Port architecture (LCP). The adapter 80 comprises a memory hierarchy which allows optimization of access latency to different internal data structures. This memory hierarchy will be described shortly. In preferred embodiments of the present invention, the adapter 80 provides separate paths for outbound (TX) data destined for the network architecture 30 and inbound (RX) data destined for the host computer system 10. Each path includes it own data transfer engine, header processing logic and network architecture interface. These paths will alas be described in detail shortly.

LCP Architecture

Referring now to FIG. 3, the LCP architecture defines a framework for the interface between local consumers running on the host computer system 10 and the adapter 80. Examples of such consumers include both applications and threads. The computer system 10 can be subdivided into a user application space 90 and a kernel space 110. The LCP architecture provides each consumer with a logical port into the network architecture 30. This port can be accessed directly from a user space 90. In particularly preferred embodiments of the present invention, a hardware protection mechanism takes care of access permission. An LCP registration is performed by in the kernel space 110 prior to transfer of data frames. The LCP architecture need not define a communication protocol. Rather, it defines an interface between the applications and the adapter 80 for transfer of data and control information. Communication protocol details may be instead set by the application and program code executing in the adapter 80. The number of channels that can be used on the adapter 80 is limited only by the amount of memory on the adapter card 80 available for LCP related information. Each LCP port can be programmable to have a specific set of features. The set of features is selected according to the specific protocol to best support data transfer between the memory 60 in the host computer system and the adapter 80. Various communication protocols can be supported simultaneously, with each protocol using a different LCP port.

The LCP architecture comprises LCP Clients 100, an LCP Manager 130 resident in the kernel space 130, and one or more LCP Contexts 140 resident in the adapter 80.

Each LCP Client 100 is a unidirectional application end point connected to an LCP port. An LCP client 100 can be located in the user application space 90 or in the kernel 110. In operation, each LCP client 100 produces commands and data to be read from the memory 60 and transferred by the adapter 80 via a TX LCP channel, or consumes data transferred by the adapter 80 to the memory 60 via an RX LCP channel.

The LCP Manager 130 is a trusted component that services request for LCP channel allocations and deallocations and for registration of read/write areas in the memory 60 for each channel. The LCP Manager 130 allows a user space application to use resources of the adapter 80 without compromising other communication operations, applications, or the operating system of the host computer system 10.

Each LCP Context 140 is the set of control information required by the adapter 80 to service a specific LCP Client 100. The LCP Context 140 may include LCP channel attributes which are constant throughout existence of the channel, such as possible commands, pointer structure, and buffer descriptor definitions. The LCP Context 140 may also include specific LCP service information for the LCP channel, such as the amount of data waiting for service, and the next address to access for the related LCP channel. The LCP context 140 is stored in memory resident in the adapter 80 to enable fast LCP context switching when the adapter 80 stops servicing one channel and starts servicing another channel.

An LCP Client 100 requiring initiation of an LCP port turns to the LCP Manager 130 and requests the allocation of an LCP channel. The LCP channel attributes are determined at this time and prescribe the behavior of the LCP port and the operations that the LCP Client 100 is authorized to perform in association with the LCP port. The LCP Client 100 is granted an address that will be used to access the adapter 80 in a unique and secure way. This address is known as a Doorbell Address.

The LCP Manager 130 is also responsible for registering areas of the host memory 60 to enable virtual to physical address translation by the adapter, and to allow user space clients to access these host memory areas without tampering with other programs.

Registration of new buffers and deregistration of previous buffers can be requested by each LCP Client 100 during run-time. Such a change, requires a sequence of information exchanges between the LCP Client 100, the LCP Manager 130, and the adapter 80.

Each LCP Client 100 and port are associated with an LCP Context 140 that provides all the information required by the adapter 80 to service pending requests sent by the LCP port for command execution.

To initiate memory transfers between the LCP Client 100 and the adapter 80, and initiate transmission of frames, the LCP Client 100 prepares descriptors holding the information for a specific operation. The LCP Client 100 then performs an I/O write to the Doorbell address mapped to the adapter 80. Writing to the Doorbell address updates the LCP Context 140 on the adapter 80, adding the new request for execution.

The adapter 80 arbitrates between various transmit LCP ports that have pending requests, and selects the next one to be serviced.

On receipt of data, the Frame and LCP for a received packet are identified. Descriptors are generated to define the operation required for the receive LCP. Execution of these descriptors by an LCP Engine of the adapter 80 stores the incoming data in an appropriate data buffer allocated to the LCP channel in the memory 60 of the host computer system 10.

For each LCP channel serviced, the adapter 80 loads the associated LCP context information and uses this information to perform the desired set of data transfers. The adapter 80 then continues on to process the next selected LCP Context 140.

Adapter Memory

Referring now to FIG. 3, and as mentioned earlier, the ISOC 120 comprises a first memory space 220 and 230 and a second memory space 240 and the adapter 80 further comprises a third level memory. The first, second, and third memory spaces for part of a memory subsystem 210 of the adapter 80. In a preferred embodiment of the present invention, the ISOC 120 comprises a TX processor (TX MPC) 150 dedicated to data transmission operations and an RX processor (RX MPC) 160 dedicated to data reception operation. In particularly preferred embodiments of the present invention, processors 150 and 160 are implemented by Reduced Instruction Set Computing (RISC) microprocessors such as IBM PowerPC 405 RISC microprocessors. Within the memory subsystem 210, the ISOC 120 comprises, in addition to the first and second memory spaces, a data cache 180 and an instruction cache 170 associated with TX processor 150, together with a second data cache 190 and second instruction cache 190 associated with RX processor 160. The difference between the three levels is the size of memory and the associated access time. As will become apparent shortly, the memory subsystem 210 facilitates: convenient access to instruction and data by both the TX processor 150 and the RX processor 160; scaleability; and sharing of resources between the TX processor 150 and the RX processor 160 in the interests of reducing manufacturing costs.

The first level memory spaces (M1) 220 and 230 comprise a TX-M1 memory space 220 and RX-M1 memory space 230. The TX-M1 memory 220 can be accessed only by the TX processor 150 and the RX-M1 memory 230 can be accessed only by the RX processor 160. In operation the first level memory spaces 220 and 230 are used to hold temporary data structures, header templates, stacks, etc. The first level memory spaces 220 and 230 both react to zero wait states. Each one of the first level memory spaces 220 and 230 is connected only to the data interface of the corresponding one of the processors 150 and 160 and not to the instruction interface. This arrangement enables both cacheable and non-cacheable first level memory areas available while maintaining efficient access to data in the first level memory spaces 230 and 240.

The second level memory space (M2) 240 is a shared memory available to both processors 150 and 160, other components of the adapter 80, and to the host computer system 10. Access to the second level memory space 240 is slower than access to the first level memory areas 220 and 230 because the second level memory space 240 is used by more agent via a shared internal bus. The third level memory space 250 is also a shared resource. In particularly preferred embodiments of the present invention the adapter 80 comprises a computer peripheral circuit card on which the first level memory spaces 220 and 230 and the second level memory space 240 are both integrated on the same ASIC as the processors 150 and 160.

The shared memory spaces 240 and 250 are generally used for data types that do not require fast and frequent access cycles. Such data types include LCP contexts 140 and virtual address translation tables. The shared memory spaces 240 and 250 are accessible to both instruction and data interfaces of the processors 150 and 160.

The adapter 80 handles transmission and reception data flows separately. The separate processor 150 and 160 for the transmission and reception path avoids the overhead of switching between task, isolates temporary processing loads in one path from the other path, and facilitates use of two embedded processors to process incoming and outgoing data streams. Referring now to FIG. 5, the ISOC 120 comprises transmission path logic 280 and reception path logic 290, and shared logic 300. The transmission path logic 280 comprises an LCP TX engine 310 for decoding specifics of each LCP channel and fetching LCP related commands for execution; TX logic 320 for controlling transfer of frames into the adapter 80, the aforementioned TX processor 150 for managing TX frame and packet processing; the aforementioned first level TX memory 220 for holding instructions and temporary data structures; and link logic 330; and logic for assisting the TX processor 150 in managing the data flow and packet processing such as routing processing for fragmentation of frames into data packets. The TX processor 150 processes tasks in series based on a polling only scheme in which the processor is interrupted only on exceptions and errors. The first level TX memory 220 is employed by the processor 150 for communicating with TX logic 320. The reception path logic 290 comprises link logic 340; hardware for assisting the aforementioned RX processor 160 in processing headers of incoming packets and transformation or assembly of such packets into frames; the aforementioned RX processor 160 for RX frame and packet processing; the aforementioned first level RX memory 230 for holding instructions; RX logic 350 for controlling transfer of frames from the network architecture 30, and an LCP RX engine 360 for decoding the specifics of each LCP channel, storing the incoming data in the related LCP data structures in the memory 60 of the host computer system, and accepting and registering pointers to empty frame buffers as they are provided by the LCP Client 100 for use by the adapter 80. The RX processor 160 processes tasks in series using a polling only scheme in which the RX processor 160 is interrupted only on exceptions or errors. The level 1 RX memory 230 is used by the RX processor 160 to communicate with the RX logic 350.

As mentioned earlier, the ISOC approach permits reduction in manufacturing costs associated with the adapter 80 and the other components thereof, such as the circuit board and the other supporting modules. The ISOC approach also increases simplicity of the adapter 80, thereby increasing reliability. The number of connections between elements of the ISOC 120 is effectively unlimited. Therefore, multiple and wide interconnect paths can be implemented. In the interests of reducing data processing overheads in the host computer system 10, data transfer operations to and from the host memory 60 are predominantly performed by the ISOC 120. The ISOC 120 also performs processing of the header of incoming and outgoing packets. During transmission, the ISOC 120 builds the header and routes it to the network architecture 30. During reception, the adapter 80 processes the header in order to determine its location in the system's memory. The level 1 memories 220 and 230 are zero wait state memories providing processor data space such as stack, templates, tables, and temporary storage locations. In especially preferred embodiments of the present invention, the transmission path logic 280, reception path logic 290, and shared logic 300 are built from smaller logic elements referred to as cores. The term core is used because there elements are designed as individual pieces of logic which have stand-alone properties enabling them to be used for different applications.

As indicated earlier, the transmission path logic 280 is responsible for processing transmission or outgoing frames. Frame transmission is initiated via the bus architecture 70 by a CPU such as CPU 50 of the host computer system 10. The ISOC 120 comprises bus interface logic 370 for communicating with the bus architecture 70. The ISOC 120 also comprises bus bridging logic 390 connecting the bus interface logic 370 to a processor local bus (PLB) 390 of the ISOC 120. The TX LCP engine 310 fetches commands and frames from the host memory 60. The TX processor 150 processes the header of each frame into a format suitable for transmission as packets on the network architecture 30. The TX logic 320 transfer the frame data without modification. The link logic 330 processes each packet to be transmitted into a final form for transmission on the network architecture 30. The link logic 330 may comprises one or more ports each connectable to the network architecture 30.

As indicated earlier, the reception path logic 290 is responsible for processing incoming packets. Initially, packets received from the network architecture 30 are processed by link logic 340. Link logic 340 recreates the packet in a header and payload format. To determine the packet format and its destination in the host memory 60, the header is processing by the RX processor 230. The link logic 340 may comprises one or more ports each connectable to the network architecture 30. The RX LCP engine is responsible for transferring the data into the host memory 60 via the bus architecture 70.

The transmission path logic 280 comprises a HeaderIn first in-first out memory (FIFO) 400 between the TX LCP engine 310 and the TX processor 220. The reception path logic comprises a HeaderOut FIFO 410 between the RX processor 230 and the RX LCP engine 360. Additional FIFOs and queues are provided in the TX logic 320 and the RX logic 350. These FIFOs and queues will be described shortly.

The shared logic 300 comprises all logical elements shared by the transmission path logic 280 and the reception path logic 290. These elements include the aforementioned bus interface logic 370, bus bridging logic 380, PLB 390, second level memory 240 and a controller 420 for providing access to the remote third level memory 250. The bus interface logic 370 operates as both master and slave on the bus architecture 70. As a slave, the bus interface logic allows the CPU 50 to access the second level memory 240, the third level memory 250 via the controller 420, and also configuration registers and status registers of the ISOC 120. Such registers can generally be accessed by the CPU 50, the TX processor 150 and the RX processor 160. As a master, the bus interface logic allows the TX LCP engine 310 and the RX LCP engine 360 to access the memory 60 of the host computer system 10. In FIG. 5, “M” denotes a master connection and “S” denotes a slave connection.

Packet Flow

Referring now to FIG. 6, packet flow through the ISOC 120 is generally symmetrical. In other words, the general structure of flow is similar in both transmit and receive directions. The ISOC 120 can be regarded as comprising first interface logic 440; a first control logic 460; processor logic 480; second control logic 470; and second interface logic 450. Packets are processed in the following manner:

A. In the transmit direction, information is brought into the ISOC 120 from the bus architecture 70 through the first interface logic. In the receive direction, information is brought into the ISOC 120 from the network architecture 30 through the second interface logic 450.

B. In the transmit direction, information brought into the ISOC 120 through the first interface logic 440 is processed by the first control logic 460. In the receive direction, information brought into the ISOC through the second interface logic 450 is processed by the second control logic 470.

C. In the transmit direction, a frame header is extracted for an outgoing frame at the first control logic 460 and processed by the processor logic 480. The processor logic 480 generates instructions for the second control logic 470 based on the frame header. The payload of the outgoing frame is passed to the second interface logic 470. In the receive direction, a frame header is extracted from an incoming frame at the second control logic 470 and processed by the processor logic 480. The processor logic 480 generates instructions for the first control logic 460 based on the frame header. The payload of the incoming frame is passed to the first control logic 460. In both directions, the processor 480 is not directly handling payload data.

D. In the transmit direction, the second control logic 470 packages the outgoing payload data according to the instructions received from the processor logic 480. In the receive direction, the first control logic 460 packages the incoming payload according to the instructions received from the processor logic 480.

E. In the transmit direction, the information is moved through the second interface logic 450 to its destination via the network architecture 30. In the receive direction, the information is moved through the first interface logic to its destination via the bus architecture 70.

An interface to software operating on the host computer system 10 is shown at 430. Similarly, interfaces to microcode operating on the processor inputs and outputs is shown at 490 and 500.

Transmit flow

Referring to FIG. 7, what follows now is a more detailed description of one example of a flow of transmit data frames through the ISOC 120. The ISOC 120 can be divided into an LCP context domain 510, a frame domain 520 and a network domain 530 based on the various formats of information within the ISOC 120. The TX LCP engine 310 comprises an LCP requests FIFO 550, Direct Memory Access (DMA) logic 560, frame logic 580, and the aforementioned LCP context logic 140. The LCP request FIFO 550, DMA logic 560, and LCP TX Context logic 590 reside in the LCP context domain 510. The frame logic 580 resides in the frame domain 520. The TX logic 320, first level TX memory space 220, and TX processor 150 straddle the boundary between the frame domain 520 and the network domain 530. The TX link logic 330 resides in the network domain 530. In particularly preferred embodiments of the present invention, the HeaderIn FIFO 400 is integral to the first level TX memory space 220. In general, an application executing on the host computer system 10 creates a frame. The frame is then transmitted using a TX LCP channel on the adapter 80. Handshaking between the application and the adapter 80 assumes a prior initialization performed by the LCP Manager 130. To add an LCP Service Request, an LCP Client 100 informs the adapter 80 that one or more additional transmit frames are ready to be executed. This is performed by writing to a control word in to a Doorbell. The Doorbell's addresses are allocated in such as way that the write operation is translated into a physical write cycle on the bus architecture 70, suing an address that is uniquely associated with the LCP port and protected from access by other processes. The adapter 80 detects the write operation and logs the new request by incrementing an entry of previous requests for the specific LCP Client 100. This is part of the related LCP Context 140. An arbitration list, retained in the memory subsystem 210 of the adapter 80 is also updated. In a simple example, arbitration uses the aforementioned FIFO scheme 550 between all transmit LCP channels having pending requests. While one LCP channel is serviced, the next LCP channel is selected. The service cycle begins when the corresponding LCP Context is loaded into the TX LCP engine 310. The LCP Context 140 is then accessed to derive atomic operations for servicing the LCP channel and to determine parameters for such operations. For example, such atomic operations may be based on LCP channel attributes recorded in the LCP Context 140. A complete service cycle typically includes a set of activities performed by the adapter 80 to fetch and execute a plurality of atomic descriptors created by the LCP Client 100. In the case of a TX LCP channel, the service cycle generally includes reading multiple frames from the host memory 60 into the memory subsystem 210 of the adapter 80. Upon conclusion, all the LCP Context information requiring modification (in other words, the LCP Service Information) is updated in the memory subsystem 210 of the adapter 80. In general, the first action performed by the adapter 80 within the LCP Service cycle, is to fetch the next descriptor to be processed.

Processing of transmission frames by the ISOC 120 typically includes the following steps:

A. Fetching the subsequent LCP port frame descriptor.

The address of the next descriptor to be fetched is stored as parts of the LCP channel's Context 140. The adapter 80 reads the descriptor from host memory 60 and decodes the descriptor based on the LCP channel attributes. The descriptor defines the size of the new frame header, the size of the data payload, and the location of these items.

B. Conversion of virtual address to physical address.

If a data buffer is referenced by virtual memory addresses in an application, the address should go through an additional process of address translation. In this case, the virtual address used by the application is translated into a physical address usable by the adapter 80 while it access the host memory 60. This is done by monitoring page boundary crossings and using physical page location information written by the LCP manager 130 into the memory subsystem 210 of the adapter 80. The virtual to physical translation process serves also as a security measure in cases where a descriptor table is created by an LCP client 100 which is not trusted. This prevents unauthorized access to unrelated areas of the host memory 60.

C. Reading the frame header.

Using physical addressing, the header and payload data of the TX frame are read from buffers in the host memory 60. The header is then stored in the TX HeaderIn HFO 400. When the header fetch is completed, the adapter 80 sets an internal flag indicating that processing of the header can be initiated by the TX processor 150.

D. Reading the frame data.

The payload data is read from the host memory 60 and stored by the adapter 80 in a data FIFO 570. The data FIFO 570 is shown in FIG. 7 as resident in the TX logic 320. However, the data FIFO 570 may also be integral to the first level TX memory space 220. Data read transactions continue until all data to be transmitted is stored in the memory subsystem 210 of the adapter 80. Following completion of the read operation, a status indication is returned to the LCP Client 100. Note that processing of the header can start as soon as the header has been read into the HeaderIn FIFO 400. There is no need to wait for the whole data to be read.

E. Processing the frame header

The header processing is performed by the TX processor 150. Header processing is protocol dependent and involves protocol information external to the LCP architecture. The TX processor 150 runs TX protocol header microcode and accesses routing tables and other relevant information already stored in the memory subsystem 210 of the adapter 80 during a protocol and routing initialization sequence. When the TX processor 150 receives an indication that a new header is waiting in the HeaderIn FIFO 400, it starts the header processing. The header processing produces one or more packet headers which are in the format employed to send packets over the network architecture 30 and include routing information. If the payload size is larger than a maximum packet size allowed by the network architecture 30, the payload is fragmented by generating several packet headers each used in connection with consecutive data segments of the original payload data to form packets for communication over the network architecture 30.

F. Queuing the packet header for transmission

A command defining the number of header words and the number of data words for a packet and the packet header itself are written by the TX processor 150 to a TX HeaderOut FIFO 540 in the first level memory space 220.

G. Merging packet header and packet data for transmission.

Transmission of a packet on the network architecture 30 is triggered whenever a command is ready in the HeaderOut FIFO 540, and the data FIFO 570 contains enough data to complete the transmission of the related packet. A Cyclic Redundancy Check (CRC) may be added to the header and data of each packet. Each complete packet is transferred to the network architecture 30 via the TX link logic 330.

The transmission process for each frame is completed when all the frame data is transmitted on the network architecture 30, by means of one or more packets. For each frame processed by the adapter 80, a status may be returned to the application via a second LCP Client 100. This status indicates the completion of the frame data transfer from the host memory 60 onto the adapter 80, completion of the frame transmission itself, or other levels of transmission status.

At any instance in time, the adapter 80 may be concurrently executing some or all of the following actions: selecting the next LCP to be serviced; initiating service for LCP channel A; executing DMA fetch of data for the last frame of LCP channel B; processing a frame header and fragmentation for LCP channel C; and, transmitting packets originated by LCP channel D.

Receive Packet Flow

Referring to FIG. 8, what follows now, by way of example only, is a description of a data frame reception by an application using an RX LCP port. The operation of the ISOC 120 may vary depending on the type of protocol supported by the LCP. Handshaking between the application and the adapter 80 assumes a prior initialization performed by the LCP manager 130. The RX LCP engine 360 comprises LCP allocation logic 620, LCP Context logic 610, and DMA logic 630 all residing in the LCP domain 520. The RX processor 160, first level RX memory space 230, and RX logic 350 all straddle the boundary between the frame domain 520 and the network domain 530. The RX link logic 340 and packet assist logic 600 reside in the network domain 530. In particularly preferred embodiments of the present invention, the HeaderOut FIFO 410 is located in the first level RX memory space 230. Frames received by the ISOC 120 from the network architecture 30 are written into LCP client buffers in the host memory 60. Availability of memory buffers is determined by the LCP RX client 100 and is indicated to the adapter 80 for insertion of incoming data frames. The LCP client 100 provides buffers by writing into a receive Doorbell on the ISOC 120, similar to the aforementioned manner in which the transmission path logic 280 is informed of new frames ready to be transmitted. The Doorbell register address is allocated such that the write operation is translated into a physical write cycle on the bus architecture 70. The adapter 80 detects the write operation and logs the new provision of empty memory areas by incrementing the number of available word entries for the specific LCP RX Client 100. The available word count is part of the related LCP context 140. Whenever an application completes processing of a received frame within a buffer, it writes to the Doorbell. The write cycle indicates the number of words in the newly available memory space. The count within the LCP context is incremented by that amount. A packet received from the network architecture 30 may be part of a larger frame that will be assembled by the adapter 80 into contiguous space in the host memory 60. Processing of received frames by the ISOC 120 generally includes the following steps:

A. Splitting packet header and data

The RX link logic 340 translates information from the network architecture 30 into a stream of packets. Each received packet is processed by the RX link logic 340 to separate the packet header from the payload data. The header is pushed into an RX HeaderIn FIFO 640 in the first level RX memory space 230. The payload is pushed into an RX data FIFO 650 in the RX logic 350. The RX data FIFO 650 may also be implemented in the first level RX memory space 230.

B. Decoding the packet header and generating and LCP frame header.

The packet header is decoded to provide fields indicative of an ID for the frame to which the packet belongs, the size of the payload, and the size of the frame data. Once the packet header is reader for the RX HeaderIn FIFO 640, an indication is sent to the RX processor 160. The RX processor processes the packet header information and generates an LCP related command including information required to transfer the packet data. Such information includes packet address and length. At the end of the header processing, a descriptor, or a set of descriptors, are written to the LCP RX HeaderOut FIFO 410, and an indication is triggered.

C. Transfer of data within the RX LCP Context.

The descriptors are fetched from the RX HeaderOut FIFO 410 by the RX LCP engine 360, and then decoded. The descriptors include the LCP number, packet address, packet data length and the source address of the data to be transferred in the memory subsystem 210 of the adapter 80. The RX LCP engine 340 uses the LCP Context information to create a target physical address (or addresses if a page is crossed) to be written to in the host memory 60 and initiates DMA transfers to write the data.

D. ISOC DMA transactions.

The ISOC 120 aims to optimize transactions on the bus architecture 70 by selecting appropriate bus commands and performing longest possible bursts.

At any instance in time, the adapter 80 may be concurrently executing some or all of the following: processing a buffer allocation for LCP channel X; initiating an inbound data write service for LCP channel A; executing a DMA store of data for LCP channel B; processing a frame assembly of a packet destined for LCP channel C; and, receiving packets for LCP channel D.

To minimize frame processing overhead on the RX processor 160 and TX processor 150, packet assist logic 600 comprises frame fragmentation logic, CRC and checksum calculation logic, and multicast processing logic.

In preferred embodiments of the present invention hereinbefore described, the adapter 80 is connected to the CPU 50 and memory 60 of the host computer system 10 via the bus architecture 70. However, in other embodiments of the present invention, the adapter 80 may be integrated into the host computer system 10 independently of the bus architecture 70. For example, in other embodiment of the present invention, the adapter 80 may be integrated into the host computer system via a memory controller connected to the host memory 60.

Additionally, in preferred embodiments of the present invention hereinbefore described, the adapter 80 was implemented in the form of a pluggable adapter card for insertion into the host computer system 10. It will however be appreciated that different implementation of the adapter 80 are possible in other embodiments of the present invention. For example, the adapter 80 may be located on a mother board of the host computer system, along with the CPU 50 and the memory 60.

In summary, hereinbefore described by way of example of the present invention is a data communications interface for a node of data processing network comprises a data transmission path, a transmission control path, a data reception path, and a reception control path. Transmission segmentation logic receives a data frame, comprising a transmission header and a transmission payload, from the node. The transmission segmentation logic supplies the transmission payload to the data transmission path and the transmission header to the transmission control path. A transmission processor in the transmission control path controls communication of data from the transmission payload to the network via the data transmission path in dependence on the transmission header. Reception segmentation logic receives a data packet, comprising a reception header and a reception payload, from the network. The reception segmentation logic supplies the reception payload to the data reception path and the reception header to the reception control path. A reception processor in the reception control path controls communication of data from the reception payload to the node via the data reception path in dependence on the reception header.

1. A data communications interface for a node of data processing network, the interface comprising:
a data transmission path;
a transmission control path;
transmission segmentation logic for receiving a data frame, comprising a transmission header and a transmission payload, from the node and supplying the transmission payload to the data transmission path and the transmission header to the transmission control path;
a transmission processor in the transmission control path for controlling communication of data from the transmission payload to the network via the data transmission path in dependence on the transmission header;
a data reception path;
a reception control path;
reception segmentation logic for receiving a data packet, comprising a reception header and a reception payload, from the network and supplying the reception payload to the data reception path and the reception header to the reception control path; and,
a reception processor in the reception control path for controlling communication of data from the reception payload to the node via the data reception path in dependence on the reception header.

2. An interface as claimed in claim 1, comprising a shared memory and a local bus providing access to the shared memory by the transmission and reception processors.

3. An interface as claimed in claim 2 wherein the shared memory comprises a store for control information to be used by the transmission and reception processors in controlling said flows of data.

4. An interface as claimed in claim 2 or claim 3, comprising a communication path for communicating information between the transmission and reception processors via the shared memory.

5. An interface as claimed in any preceding claim, comprising bus interface logic for connecting the local bus, the transmission data channel, and the reception data channel to a bus architecture of the node.

6. An application specific integrated circuit, comprising a data communication interface as claimed in any preceding claim.

7. A network interface card for insertion into a computer system, the network interface card comprising a printed circuit board and a data communications interface as claimed in any of claims 1 to 5 mounted on the printed circuit board.

8. A computer system comprising: a central processing unit; a memory; a data communications interface as claimed in any of claims 1 to 5; and, a bus architecture interconnecting the central processing unit, the memory, and the data communications interface.

9. A data processing network comprising a plurality of computer systems as claimed in claim 8 and a network architecture interconnected the computer systems.

10. A method of communicating data to and from a node in a data processing network, the method comprising:
receiving, via transmission segmentation logic, a data frame, comprising a transmission header and a transmission payload, from the node;
supplying, via the transmission segmentation logic, the transmission payload to a data transmission path and the transmission header to a transmission control path;
controlling, via a transmission processor in the transmission control path, communication of data from the transmission payload to the network via the data transmission path in dependence on the transmission header;
receiving, via reception segmentation logic, a data packet, comprising a reception header and a reception payload, from the network;
supplying, via the reception segmentation logic, the reception payload to a data reception path and the reception header to a reception control path; and,
controlling, via a reception processor in the reception control path, communication of data from the reception payload to the via the data reception path in dependence on the reception header.
